(19) United States
(12) Patent Application Publication
(10) Pub. No.: US 2004/0134303 A1
(43) Pub. Date: Jul. 15, 2004

(54) Motorcycle handlebar brace pad

(76) Inventor: Daniel L. Durham, Fremont, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/340,239

(22) Filed: Jan. 10, 2003

(51) Int. Cl. B62K 21/12

(52) U.S. Cl. 74/551.8

(57) ABSTRACT

An improved motorcycle handlebar brace pad includes a foam pad having a central section and two end sections at opposite ends of the central section, wherein the central section has a larger circumference than the end sections. The reduced diameter end sections eliminate interference with attachment of a conventional front number plate and facilitate coverage of substantially the entire length of the brace bar, while providing an enlarged area for display of printed indicia and more protective padding to reduce risk of injury.

### FIELD OF THE INVENTION

This invention relates to motorcycle handlebar brace pads.

### BACKGROUND OF THE INVENTION

A pad is typically mounted on a brace bar that extends horizontally across the handlebar of a motorcycle to reduce the risk of injury to a motorcyclist in the event that a portion of the motorcyclist's body collides with the brace bar. The brace bar is used to reinforce and stabilize the handlebar to prevent bending of the handlebar during operation of the motorcycle on rough terrain at high speeds, such as during motorcycle racing on off-road courses.

Conventional motorcycle brace bar pads typically comprise a cylindrically shaped flexible plastic foam (e.g., polyurethane foam) body having a longitudinal slit that extends radially to a cylindrical hollow volume which extends longitudinally from one end to the opposing end of the foam body along the central axis of the cylindrically shaped foam body. The slit allows the flexible foam body to be installed on the brace bar by passing the brace though the slit to the hollow volume. A flexible fabric cover sheet having fasteners (such as Velcro® hook and loop type fastener) at its ends is wrapped around the brace pad to protect the pad from dirt, mud and the like, and to hold the pad on the brace bar. The fabric cover (which may be comprised of a woven nylon fabric, flexible vinyl sheet material, or the like) typically has printed indicia such as logos, ornamentation or the like, on its outer exposed surface, and, therefore, may also serve an aesthetic function.

During a motorcycle race, competitors often desire to display personalized printed material, such as a photograph, course map, printed instructions, reminders, inspirational messages, or the like, in plain view. A preferred location for such personalized printed material is on the fabric cover for the brace pad. Motorcyclists will, for example, tape or otherwise attach the desired personalized printed material onto the brace pad cover. Conventional methods of attachment of personalized printed material onto the brace pad cover is inconvenient, ineffective and unsightly. For example, a motorcyclist employing conventional methods of attaching personalized printed material to a brace pad cover needs to have adhesive tape or other fastening means at his/her disposal. Adhesive tape and other fastening means are ineffective because they do not protect the printed material from dirt, mud, and the like, and often peel away from the brace pad cover during a race, particularly if the course is wet.

Commonly owned U.S. patent application Ser. No. 10/054,264 discloses a brace bar pad cover having a transparent pocket that provide a convenient means for plainly displaying desired personalized printed material, and protects the printed material from exposure and damage from dirt, mud, and the like.

A disadvantage with conventional motorcycle handlebar brace pads is that they have a uniform circular cross section of constant diameter along their entire length to facilitate manufacturing and installation of the pad, and to accommodate mounting of a front number plate during competitions. This is a disadvantage because the cross-sectional size and shape of the central portion of the motorcycle handlebar brace pad is dictated by various factors that are unrelated to its primary function, i.e., to absorb energy of impact between a motorcyclist and the crossbar. More specifically, it would be desirable to maximize protection at the central portion of the motorcycle handlebar brace pad where impact between the head of a motorcyclist and the handlebar brace is most likely to occur. Further, it would be desirable to provide a larger viewing surface upon which personalized printed material may be displayed. However, the conventional, relatively narrow cross-sectional profile for motorcycle handlebar brace pads has been deemed necessary to allow installation of the pad on a handlebar brace and allow mounting of a conventional front number plate.

A further disadvantage with conventional motorcycle brace pads is that they rotate freely around the brace bar. As a result, any personalized printed material mounted on the brace pad cover can easily rotate out of view due to vibrations during a race.

Accordingly, it would be desirable to provide a motorcycle handlebar brace pad that can be easily installed on a conventional brace bar in a conventional manner and accommodate mounting of a conventional front number plate, while providing a larger display surface, such as for displaying personalized printed material and/or more padding material at the central portion of the pad where a collision with a motorcyclist's head is most likely to occur. Further, it would be desirable to provide a motorcycle handlebar brace pad that will not freely rotate, whereby personalized printed material may be retained in a fixed position that is always in plain view.

### SUMMARY OF THE INVENTION

The invention provides an improved motorcycle cross bar brace pad having an enlarged central portion. The enlarged central portion of the pad provides a larger display for printed indicia on the pad cover (e.g., logos, trademarks, ornamentation, or the like printed directly on the pad cover), and/or for personalized printed matter displayed on or inserted into a transparent pocket on the pad cover. The enlarged central section also provides more protective padding that covers bolts and/or other fasteners used for mounting the handlebar to the motorcycle and spreads any impact over a larger area, thus further reducing the risk of injury in the event of a collision between the motorcyclist and the handlebar brace.

In accordance with an aspect of the invention, the motorcycle handlebar brace pad includes a foam pad having a central section and two end sections at opposite ends of the central section, wherein the central section has a larger circumference than the end sections. The reduced diameter end sections eliminate interference with attachment of a conventional front number plate and facilitate coverage of substantially the entire length of the brace bar.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of a conventional motorcycle having a handlebar brace.

FIG. 2 is a perspective view of the motorcycle of FIG. 1 with a conventional cylindrically shaped brace pad mounted on the handlebar brace.

FIG. 3 is a perspective view of the motorcycle and conventional handlebar brace pad shown in FIG. 2, with a brace pad cover wrapped around the brace pad.

FIG. 4 is a perspective view of the motorcycle of FIG. 1 with an improved brace pad of the invention.

FIG. 5 is an end view of the improved brace pad shown in FIG. 4.

FIG. 6 is a top plan view of a cover for holding the brace pad on the brace.

FIG. 7 is a perspective view of the cover wrapped around the brace pad.

### DESCRIPTION OF THE PREFERRED EMBODIMENTS

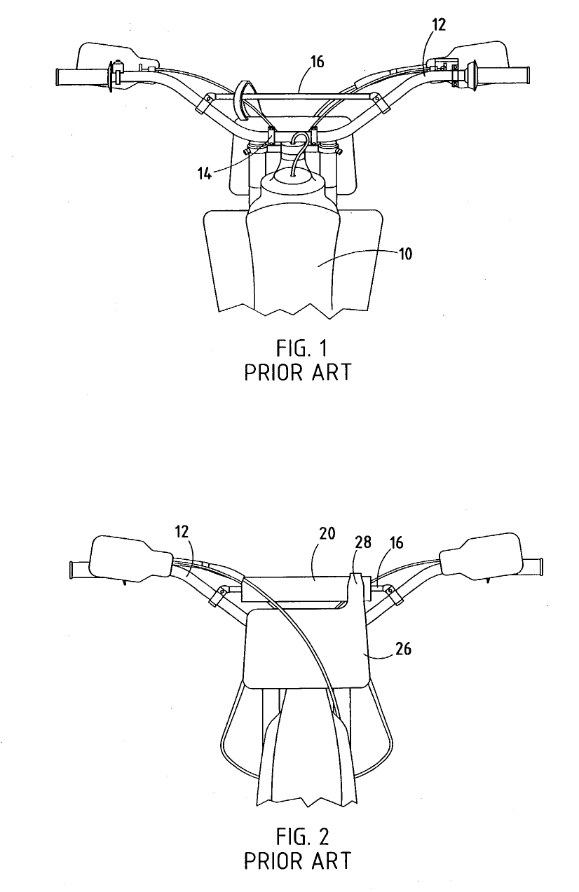

There is shown in FIG. 1 a typical motorcycle used for off-road sports. The motorcycle 10 includes a handlebar 12 retained on a bracket 14. A brace bar 16 extends horizontally across the handlebar 12 to add structural rigidity, thereby structurally reinforcing and stabilizing handlebar 12 to prevent bending of the handlebar during off-road motor sporting activities, such as racing.

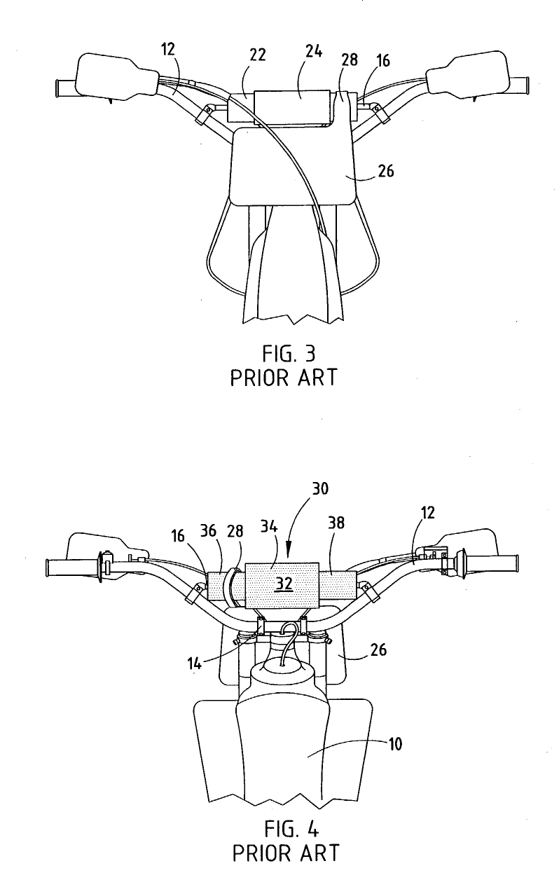

As shown in FIG. 2, brace bar 16 is typically provided with a pad 20 having a uniform circular cross-sectional profile. As shown in FIG. 3, the conventional cylindrical pad 20 is protected and retained on brace bar 16 by wrapping a flexible cover 22 around pad 20. The exposed surface of flexible cover 22 is typically provided with brightly colored ornamental and/or promotional printed indicia. Alternatively, or in addition, as disclosed in commonly owned U.S. application Ser. No. 10/054,264, pad cover 22 may be provided with a pocket 24 into which a photograph or other personalized printed matter may be inserted for display. A front number plate 26 mounted on motorcycle 10 includes a strap 28 which is wrapped around covered pad 20. Strap 28 of conventional front number plate 26 is sized and configured to wrap around a conventional cylindrical pad 24 having a predetermined diameter.

As shown in FIG. 4, the handlebar brace pad 30 of the invention is designed to be mounted on a conventional motorcycle handlebar brace bar 16 and to accommodate strap 28 of conventional front number plate 26, while providing a larger display surface 32. This is achieved by configuring brace pad 30 so that it includes a larger diameter central section 34 and smaller diameter end sections 36 and 38.

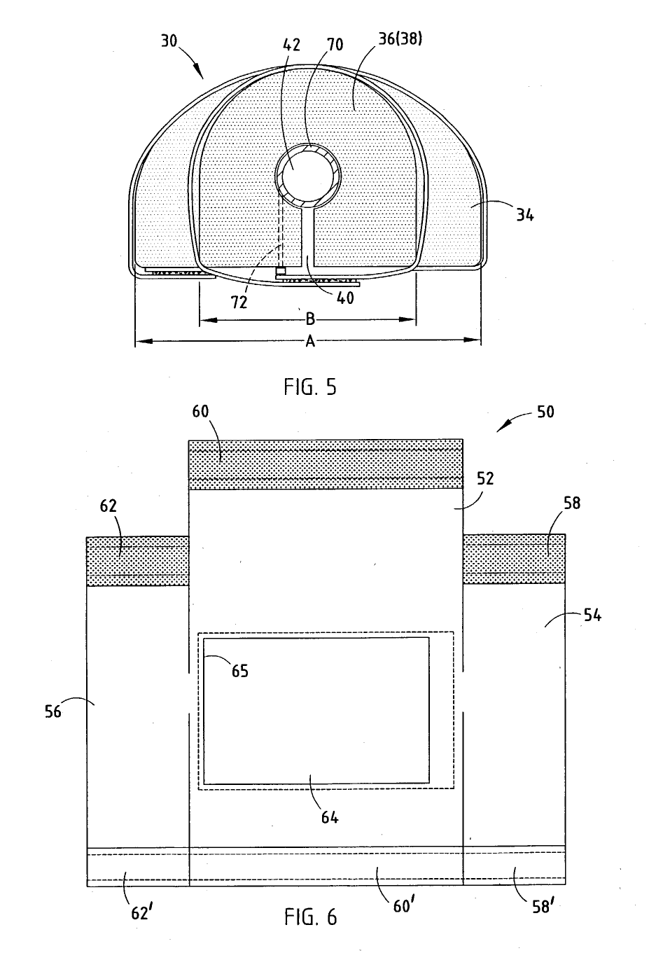

As shown in greater detail in FIG. 5, the central section 34 has a width A that is substantially greater than the width B of end section 36 (or 38). A slit 40 and hollow volume 42 extends along the entire length of the pad to facilitate mounting of the pad on a handlebar brace. Base pad 30 may be fabricated of generally any foamed plastic material having suitable energy absorption properties. Examples of suitable materials include polyurethane foam and polyolefin foams.

Foam pad 30 may be manufactured by extruding a foam having the profile of the central portion, and then the reduced diameter end portions can be shaped by cutting excess foam from the extruded profile. Alternatively, the desired finished shape can be formed in a closed mold cavity.

Pad cover 50 is shown flat in FIG. 6, and wrapped around pad 30 in FIG. 7. Cover 50 includes a central section 52 sized and configured to wrap around central section 34 of pad 30 and end sections 54 and 56 sized and configured to wrap around end sections 36 and 38 of pad 30. Each of the sections preferably includes fasteners, such as Velcro® fasteners 58-58′, 60-60′ and 62-62′. Each of the fasteners includes a hook portion comprised of an array of miniature hooks (62, 60 and 58) that engage a pad comprised of a fabric having loops (62′, 60′ 58′) that are engaged by the hooks. Desirably, cover 50 includes a pocket 64 that may be located either on the inside or on the outside of the cover. Pocket 64 may be stitched, fusion welded, or otherwise attached.

In order to permit viewing of printed material, central section 52 of cover 50 and/or pocket 64 may be transparent.

Central portion 32 of pad 30 preferably has a display face 32 that is either generally flat or has only a slight amount of curvature so as to provide a relatively large display surface that is within plain view of the motorcyclist.

In accordance with another preferred aspect of the invention, pad 30 may be provided with a ring clamp 70 embedded within the pad and having an adjustment screw 72 extending out of the pad to tighten the pad onto the brace bar so that it will not rotate during normal use, such as during a off-road race.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A motorcycle handlebar brace pad, comprising:
a foam pad having a central section and two end sections at opposite ends of the central section, the central section having a larger circumference than the end sections.

2. The brace pad of claim 1, further comprising a clamp disposed within the pad to facilitate securement of the brace pad to a brace bar so that rotation of the brace pad with respect to the brace bar is prevented.

3. A motorcycle handlebar brace pad in combination with a pad cover, comprising:
a foam pad having a central section and two end sections at opposite ends of the central section, the central section having a larger circumference than the end sections; and
a pad cover having a central section configured to wrap around the central section of the foam pad, and two end sections connected to the central section, each end section configured to wrap around the end sections of the foam pad.

4. The combination of claim 3, wherein the pad cover includes a pocket.

5. The combination of claim 4, wherein the pocket is transparent.

6. The combination of claim 4, wherein the central section of the cover is transparent.

7. The combination of claim 3, further comprising a clamp disposed within the pad to facilitate securement of the brace pad to a brace bar so that rotation of the brace pad with respect to the brace bar is prevented.
